(19) United States
(12) Patent Application Publication
(10) Pub. No.: US 2017/0369763 A1
(43) Pub. Date: Dec. 28, 2017

(54) METHYLHYDROXYETHYL CELLULOSE AS CEMENT ADDITIVE FOR USE AT ELEVATED TEMPERATURES

(71) Applicant: Dow Global Technologies LLC, Midland, MI (US)

(72) Inventors: Pramod D. Patil, Sugar Land, TX (US); Alexandra Hild, Soltau (DE)

(73) Assignee: Dow Global Technologies LLC, Midland, MI (US)

(21) Appl. No.: 15/532,214

(22) PCT Filed: Jan. 11, 2016
(86) PCT No.: PCT/US2016/012792

§ 371 Date: Jun. 1, 2017

Related U.S. Application Data
(60) Provisional application No. 62/102,187, filed on Jan. 12, 2015.

(51) Int. Cl. C09K 8/487; C04B 24/38; C04B 28/02; C09K 8/493

(52) U.S. Cl. CPC C09K 8/487; C09K 8/493; C04B 24/383; C04B 28/02

(57) ABSTRACT

Disclosed is an aqueous cementing slurry composition and a method of use thereof for cementing a pipe or casing in a borehole of a well using an aqueous cementing slurry composition comprising (a) a hydraulic cement, (b) a methylhydroxyethyl cellulose (HEMC) having an ethylene oxide molar substitution (EO MS) of from 0.16 to 0.22 and a methyl degree of substitution (M DS) of from 1.35 to 1.45, (c) water, and optionally (d) one or more other additives conventionally added to aqueous cementing compositions useful in cementing casings in the borehole of wells. Preferably, the aqueous cementing slurry composition is pumped downwardly into said casing, pumped upwardly into the annulus surrounding said casing until said aqueous composition fills that portion of the annular space desired to be sealed, and then maintaining said aqueous cementing composition in place until the cement sets.

### FIELD OF THE INVENTION

This invention relates to the use of a methylhydroxyethyl cellulose (HEMC) as an additive for cement compositions for use during construction of a well penetrating a subterranean formation to form a wellbore. Said HEMC having a specific degree of substitution of methyl group and molar substitution of ethylene oxide provides improved fluid loss control, especially at elevated temperatures.

### BACKGROUND OF THE INVENTION

During construction of a well penetrating a subterranean formation, a rotary drill is typically used to bore through the subterranean formation to form a wellbore. Once the wellbore has been drilled, a pipe or casing is lowered into the wellbore. A cementitious slurry and a displacing fluid, such as a drilling mud or water, is pumped down the inside of the pipe or casing and back up the outside of the pipe or casing through the annular space between the exterior of the pipe or casing and the wellbore. The cementitious slurry is then allowed to set and harden.

A common problem in well cementing is the loss of fluid from the cementitious slurry into porous low pressure zones in the formation surrounding the well annulus. Fluid (liquid and/or gas) loss is undesirable since it can result in dehydration of the cementitious slurry. In addition, it may cause the formation of thick filter cakes of cement solids. Such filter cakes may plug the wellbore. In addition, fluid loss can damage sensitive formations. Minimal fluid loss is desired therefore in order to provide better zonal isolation and to minimize formation damage by fluid invasion.

Common cement additives used to control fluid loss and gas migration from the slurry to the porous permeable formation include hydroxyethyl cellulose (HEC), carboxymethylhydroxyethyl cellulose (HEMC), acrylamidomethylpropane sulfonic acid (AMPS), polyethyleneimines, styrene butadiene rubber latexes, and polyvinyl alcohol. Recently, U.S. Pat. No. 8,689,870 disclosed the use of hydroxyethyl methyl cellulose (HEMC) as an additive for multipurpose cements employed in uses at lower temperatures (i.e., 120° F. to 170° F.).

Further, microparticulate additives, such as silica fume, may be used in combination with such additives to make the cement composition less permeable. Such materials work best, however, in cement compositions that have a high cement density and a low water to cement ratio. The lower the cement density and the higher water to cement ratio, the greater the quantity of water soluble or film-forming additives that are required to reduce gas migration to an acceptable level and keep channeling to a minimum. Lower cement densities require greater amounts of traditional additives. This quantity can increase to a point that is cost prohibitive for lower density cement compositions.

Accordingly, it would be desirable to find an alternative cost effective cementing composition for cementing pipes or casings within wellbores which exhibits reduced fluid loss, especially at high temperatures e.g., above 170° F., while maintaining an adequately low viscosity at ambient (i.e., pumping) temperatures.

### SUMMARY OF THE INVENTION

The present invention is such an aqueous cementing slurry composition and method to use thereof.

In one embodiment, the present invention is an aqueous cementing slurry composition for cementing a pipe or casing in a borehole of a well comprising (a) a hydraulic cement, (b) a methylhydroxyethyl cellulose (HEMC) having an ethylene oxide molar substitution (EO MS) of from 0.1 to 0.33 and a methyl degree of substitution (M DS) of from 1.3 to 1.5, preferably an EO MS of from 0.16 to 0.22 and a M DS of from 1.35 to 1.45, preferably in an amount of from 0.1 to 0.5 weight percent based on the weight of the cement (bwoc) (c) water, and (d) optionally one or more other additives conventionally added to cementing compositions useful in cementing a pipe or casings in the borehole of wells.

Another embodiment of the present invention is the aqueous cementing slurry composition disclosed herein above wherein the amount of fluid loss of the cementing composition is less than 30 cm3/30 minutes at 165° F. according to ISO 10B-2.

Another embodiment of the present invention is the aqueous cementing slurry composition disclosed herein above wherein the HEMC comprise particle size fractions of: (1) at least 95 percent less than 0.8 mm, (2) at least 70 percent less than 0.63 mm, and (3) at least 30 percent less than 0.2 mm, wherein particle size fractions are determined by laser diffraction.

Another embodiment of the present invention is the aqueous cementing slurry composition disclosed herein above having a cement slurry viscosity equal to or less than 300 cp at 20° C. using a FANN 35 viscometer as described in ASTM D-2364.

Another embodiment of the present invention is a method for cementing a pipe or casing in a borehole of a well comprising the use of the cementing composition disclosed herein above comprising the steps of: i) introducing into the borehole the cementing composition and ii) allowing the cementing composition to set.

### DETAILED DESCRIPTION OF THE INVENTION

Fluid loss, or like terminology, refers to any measure of water released or lost from a slurry over time. Fluid loss is measured in accordance with Recommended Practice for Testing Well Cements, API Recommended Practice 10B-2, 23^{rd} Edition (2002) and is expressed in cm³/30 minutes. According to the invention, slurries are measured at a pressure of 100 pounds-force per square inch gauge (psig) and the indicated test temperature.

Free fluid, as used herein, refers to the aqueous phase that easily separates from a slurry under gravity separation over time. To test for free fluid see, Recommended Practice for Testing Well Cements, API Recommended Practice 10A, 23^{rd} Edition (2002). Briefly, the cement slurry is prepared and conditioned to the test temperature. The slurry is then poured into a graduated cylinder which is placed in a water bath that is maintained at the test temperature. The free fluid is the amount of water, in volume percent, which separates after two hours.

By weight of cement (bwoc) refers to a weight of an additive in dry form as added to a cement composition based on the cement solids only. For example, 2 parts weight of an additive which is added to 100 parts weight of cement solids is present in an amount of 2% bwoc.

The aqueous cementing slurry composition of the present invention comprises (i) a hydraulic cement, (ii) a hydroxyethyl methyl cellulose, (iii) water, and (iv) one or more other additives conventionally added to aqueous cementing slurry compositions useful in cementing pipes or casings in the borehole of a well.

All types of water generally encountered in drilling operations are useful in the cementing composition of the present invention, i.e., fresh and tap water, natural and synthetic sea water, and natural and synthetic brine. The most commonly used source of water is fresh water from wells, rivers, lakes, or streams when drilling on land, and sea water when drilling in the ocean. The aqueous cementing slurry composition generally contains about 30 to 200 weight percent water based on the weight of the cementing composition (% bwoc). The amount of water is given as a weight percent based on the weight of the cement (% bwoc). To exemplify, an aqueous cementing slurry composition comprising 200% bwoc water would comprise 200 weight units of water and 100 weight units of cement for a total of 300 weight units. If said example additionally had 5 bwoc additives, the aqueous cementing solution would comprise 200 weight units of water, 100 weight units of cement, and 5 bwoc additives for a total of 305 weight units. In another example, an aqueous cementing slurry composition comprising 40% bwoc water would comprise 40 weight units of water and 100 weight units of the cement for a total of 140 weight units.

The cementing composition of the present invention comprises (i) any of the known hydraulic cements, and preferably, contains Portland cement based hydraulic cement such as API types A through J, preferably H. Typically, the cementing composition comprises a hydraulic cement in an amount of from 40 weight percent to 99.9 weight percent based on the weight of the cementing composition. Preferably hydraulic cement is present in an amount of from equal to or greater than 40 weight percent based on the weight of the cementing composition, preferably equal to or greater than 45 weight percent, more preferably equal to or greater than 50 weight percent, and even more preferably equal to or greater than 55 weight percent based on the weight of the cementing composition. Preferably the hydraulic cement is present in an amount of from equal to or less than 99.9 weight percent based on the weight of the cementing composition, preferably equal to or less than 98 weight percent, more preferably equal to or less than 95 weight percent, and even more preferably equal to or less than 80 weight percent based on the weight of the cementing composition. For example, if the cementing composition is 40 weight percent cement, it comprises 40 weight units of cement and 60 weight units of additional components (i.e., HEMC, water, and any additional additives if present).

The fluid loss additive in the cementing composition of the present invention is (ii) a hydroxyethyl methyl cellulose (HEMC). The base polymer for HEMC is cellulose, which is a polysaccharide built up from 1,4-anhydroglucose units (AGU). The process for making HEMC typically starts with an alkalization step, which serves to swell the cellulose making the cellulose chains available for the chemical reaction. The alkalization step acts to catalyze the modification reactions with ethylene oxide. Each AGU has three hydroxyl groups available for reaction. The reaction of one ethylene oxide molecule to one of the hydroxyl groups on an AGU results in a new hydroxyl group that is also reactive. The newly formed hydroxyl group has a reactivity comparable to that of the hydroxyl groups on the AGU which means that besides the reaction of the hydroxyl groups on the AGU there is also a chain growth reaction occurring. The outcome is that short oligomeric (ethylene oxide) chains can be formed. Ethylene oxide molar substitution (EO MS) is the average total number of ethylene oxide groups per AGU.

The HEMC of the present disclosure includes hydroxyethyl groups, as discussed herein, and is further substituted with one or more methylene substituents. The EO MS of the polymers prepared from hydroxyethyl cellulose can be determined either by simple mass gain or using the Morgan modification of the Zeisel method: P. W. Morgan, Ind. Eng. Chem., Anal. Ed., 18, 500-504 (1946). The procedure is also described in ASTM method D-2364 (2007). In one or more embodiments, the HEMC has an EO MS from 0.1 to 0.33, preferably from 0.16 to 0.22. All individual values and subranges from 0.1 to 0.33 of the EO MS value are included herein and disclosed herein.

The average number of moles of methylene substituent(s) per mole of anhydroglucose unit is designated as methylene degree of substitution (M DS). The M DS is measured using the Morgan modification of the Zeisel method as provided herein, but using a gas chromatograph to measure the concentration of cleaved methylene groups. An example of a gas chromatographic method that can be used for this purpose is described in ASTM method D-4794 (2009). In one or more embodiments, HEMC has an M DS from 1.3 to 1.5, preferably from 1.35 to 1.45. All individual values and subranges from 1.3 to 1.5 of the M DS value are included herein and disclosed herein.

The HEMC is present in the cement composition of the present invention in an amount of from 0.01 to 3% bwoc. Preferably the HEMC is present in an amount of from equal to or greater than 0.01% bwoc, preferably equal to or greater than 0.05 bwoc, more preferably equal to or greater than 0.1% bwoc, and even more preferably equal to or greater than 0.16% bwoc. Preferably the HEMC is present in an amount of from equal to or less than 3% bwoc, preferably equal to or less than 2% bwoc, more preferably equal to or less than 1% bwoc, even more preferably equal to or less than 0.5% bwoc, and even more preferably equal to or less than 0.22% bwoc. The preferable amount of HEMC in the cementing composition of the present invention is in the range of from 0.1 to 0.33 bwoc.

The HEMC of the cementing composition can have a variety of weight-average molecular weights (M_{w}). For example, the HEMC of the cementing composition can have a M_{w} of 500,000 to 3,000,000 Daltons. Preferably the hydrophobically modified polymer has a weight-average molecular weight of equal to or greater than 500,000 Daltons, preferably equal to or greater than 1,000,000 Daltons, and more preferably equal to or greater than 1,500,000 Daltons. Preferably the hydrophobically modified polymer has a weight-average molecular weight of equal to or less than 3,000,000 Daltons, preferably equal to or less than 2,000,000 Daltons.

In addition, the HEMC can have a molecular weight distribution or polydispersity, as measured by the ratio of weight-average molecular weight versus number-average molecular weight (M_{w}/Mₙ). For example, the HEMC has a M_{w}/Mₙ of 4 to 40. All individual values and subranges of the M_{w}/Mₙ of 4 to 40 are included herein and disclosed herein. Preferably the HEMC has a M_{w}/Mₙ of equal to or greater than 4, preferably equal to or greater than 8, and more preferably equal to or greater than 14. Preferably the HEMC has a M_{w}/Mₙ of equal to or less than 40, preferably equal to or less than 30, and more preferably equal to or less than 27. Examples of such M_{w}/Mₙ ranges include 4 to 27; 4 to 30; 8 to 27; 8 to 30; 8 to 40; 14 to 27; 14 to 30; and 14 to 40.

The molecular weights (number-average and weight-average) are preferably determined via size-exclusion chromatrography (SEC) using a light-scattering detector.

The cementing composition of the present invention may further comprise (d) one or more other additives conventionally added to cement compositions useful in cementing pipes or casings in the borehole of a well in the amounts normally used. These additives can include, for example, cement accelerators, such as calcium chloride, sodium chloride, gypsum, sodium silicate and sea water; light-weight additives, such as bentonite, diatomaceous earth, coal, perlite and pozzolan; heavy-weight additives, such as hematite, ilmenite, barite, silica flour, and sand; cement retarders, such as lignins, sodium or calcium lignosulfonates, HEMC (carboxymethylhydroxyethylcellulose ether) and sodium chloride; additives for controlling lost circulation, such as gilsonite, walnut hulls, cellophane flakes, gypsum cement, bentonite-diesel oil and fibers; filtration control additives, such as cellulose dispersants, HEMC and latex; antifoaming agents, such as FP-L6 from B.J. Services Company; surfactants; formation conditioning agents; and expanding additives.

The cementing compositions of the present invention may be prepared according to conventional means as are well known in the art. At a minimum, the slurries include water, cement, and an HEMC. One or more of the cement, HEMC, and optional additives may be pre-mixed and added together or may be added separately in any order to the slurry. For example, they may be added to the cement by dry mixing and then added to the water or alternatively, by a continuous process where the additives and water are concurrently added to the cement. Alternatively, the one or more additives may be pre-mixed with the cement then mixed with the water, then one or more of the additives added directly to the slurry.

In a preferred embodiment, the aqueous cementing slurry composition of the present invention is made by dry blending the hydraulic cement, HEMC, and optionally one or more other additives to form a dry blend cementing composition which is then added to water or the water added to it and mixed prior to pumping down the borehole or the dry blend cementing composition is added directly to the water as it is being pumped down the borehole. Alternatively, the solids (except for the HEMC) may be dry mixed, added to the water (or water added to them) combined with the HEMC and then mixed further to form an aqueous cementing slurry composition of the present invention.

The aqueous cementing slurry compositions of the present invention are generally prepared to have a density of from about 5 to about 30 pounds per gallon.
The HEMC useful in the process of the present invention have particle size fractions of: (1) from 95 to 100 percent less than 0.8 mm, (2) from 70 to 100 percent less than 0.63 mm, and (3) from 15 to 30 percent less than 0.2 mm, wherein particle size fractions are determined by laser diffraction.

The aqueous cementing slurry compositions which are particularly useful for the method of this invention, generally have a viscosity of from 1 to 5000 centipoise (cP), preferably from 1 to 1000 cP, more preferably from 1 to 500 cP, most preferably from 1 to 300 cP measured at 20° C. using a FANN 35 viscometer as described in ASTM D-2364. The most preferred aqueous cementing slurry compositions of the present invention have a viscosity equal to or less than 300 cP.

Preferably, the aqueous cementing slurry compositions have a fluid loss at 250° F. of equal to or less than 150 cm³/30 minutes, more preferably equal to or less than 100 cm³/30 minutes, even more preferably equal to or less than 50 cm³/30 minutes, and most preferably equal to or less than 30 cm3/30 minutes when measured as described in Recommended Practice for Testing Well Cements, API Recommended Practice 10B-2, 23^{rd} Edition (2002).

One embodiment of the present invention is a method to cement a pipe or casing in a borehole of an oil or gas well with the aqueous cementing composition of the present invention. After a borehole of an oil or gas well is drilled, pipe or casing is run into the well and is cemented in place by filling the annulus between the borehole wall and the outside of the casing with the cementing composition of the present invention, which is then permitted to set. The resulting cement provides a sheath surrounding the casing that prevents, or inhibits, communication between the various formations penetrated by the well. In addition to isolating oil, gas and water-producing zones, the cement also aids in (1) bonding and supporting the casing, (2) protecting the casing from corrosion, (3) preventing blowouts by quickly forming a seal, (4) protecting the casing from shock loads in drilling deeper and (5) sealing off zones of lost circulation. The usual method of cementing a well is to pump the aqueous cementing slurry composition downwardly through the casing, outwardly through the lower end of the casing and then upwardly into the annulus surrounding the casing. The upward displacement of the aqueous cementing slurry composition through the annulus can continue until some of the aqueous cementing slurry composition returns to the well surface, but in any event will continue past the formations to be isolated.

For example, a preferred method of the present invention is cementing a pipe or casing in a borehole of a well comprising suspending the casing in the borehole, pumping downwardly into said casing an aqueous cementing slurry composition comprising (a) a hydraulic cement, (b) an HEMC, (c) water, and optionally (d) one or more other additives conventionally added to aqueous cementing slurry compositions useful in cementing casings in the borehole of wells, then pumping said aqueous cementing slurry composition upwardly into the annulus surrounding said casing, continuing said pumping until said aqueous composition fills that portion of the annular space desired to be sealed and then maintaining said aqueous cementing slurry composition in place until the cement sets or harden to a solid mass.

The cementing compositions of the present invention are characterized by good stability and little or no fluid loss at elevated temperatures (i.e., 190° F. or higher), the presence of little or no measureable free water, a viscosity designed for optimum particle suspension, optimum pumpability, especially at elevated wellbore temperatures (i.e., at or above 190° F. or preferably at or above 250° F.), flow properties sufficient to facilitate and maintain laminar and/or plug flow, adequate gel strength to provide thixotropic properties to the slurry when pumping ceases.

The present invention is further illustrated by the following examples which are not to be construed to limit the scope of the present invention. Unless otherwise indicated, all percentages and parts are by weight.

### Examples

### Preparation of HEMC.

The following process is used to make Example 1 and Comparative Examples A to C: The ground cellulose flock (1,4-anhydroglucose units (AGU) is added to a 5 L autoclave. After purging the autoclave three times with nitrogen the reactor is heated to 40° C. Then dimethylether (DME), and methyl chloride (MCl-1) are jet into the autoclave. Caustic soda (50 weight percent NaOH-1) is added in 3 portions during 2 minutes at a temperature of 40° C. The reaction mixture is held at 40° C. for 30 minutes. Ethylene oxide (EO) is added. The mass is heated to 80° C. for 45 minutes. At 80° C. a second amount of methylene chloride (MCl-2) is injected quickly to the mass. Afterwards more 50 weight percent sodium hydroxide (NaOH-2) is added in 7 portions over 30 minutes followed by a specified cook-off time at 80° C. After the cook-off time, the reaction product is washed with hot water and neutralization with formic acid. Granulation takes place at 65 percent humidity for 30 minutes using a Bosch lab granulator. After drying at 55° C. in a circulating air drying cabinet over night the product is milled in an alpine lab mill with 0.5 mm milling sieve without milling channel.

The reactant amounts, reaction times, and EO MS and M DS for Example 1 and Comparative Examples A to C are summarized in Table 1. The EO and M DS values listed in Table 1 are determined according to ASTM method D-2364 (2007). Particle size is determined by laser diffraction according to ISO 13320 Particle size analysis—laser diffraction methods. The Laser diffraction sensor HELOS with the RODOS universal dry dispersing unit (Sympatec GmbH, Clausthal-Zellerfeld, Germany) lens R5: (4.5-875 μm) is used. Measurements typically have ±1% deviation with respect to the standard.

TABLE 1

| | Ex 1 | Com Ex A | Com Ex B | Com Ex C |
|---|---|---|---|---|
| AGU, mol | 1.5 | 1.5 | 1.5 | 1.5 |
| DME, mol/mol AGU | 4.7 | 4.7 | 4.7 | 4.7 |
| MCl-1, mol/mol AGU | 3.2 | 3.2 | 3.2 | 3.2 |
| NaOH-1, mol/mol AGU | 1.9 | 1.9 | 1.9 | 1.9 |
| EO, mol/mol AGU | 0.3 | 0.24 | 0.26 | 0.24 |
| MCl-2, mol/mol AGU | 1.3 | 1.3 | 1.3 | 1.3 |
| NaOH-2, mol/mol AGU | 0.2 | 0.31 | 0.65 | 0.63 |
| Cook-off time, minutes | 70 | 70 | 70 | 70 |
| EO MS | 0.18 | 0.14 | 0.32 | 0.13 |
| M DS | 1.38 | 1.46 | 1.65 | 1.62 |
| Particle size, wt % less | 17.5 | 57.2 | 98 | 45.4 |
| than 0.2 mm | | | | |

### Preparation of Aqueous Cementing Slurry Compositions.

The following procedure exemplifies a standard procedure for making aqueous cementing slurry compositions, and measuring the resulting performance properties related to viscosity and fluid loss. In addition, one skilled in the art will appreciate that this is an exemplary procedure and that other components can be substituted or removed in the procedure to make a similar cementing composition.

Aqueous cementing slurry compositions are prepared by mixing 15.5 ppg neat Joppa Class H Portland cement and 0.3 weight percent sodium lignosulfonate (SLS) as set retarder with 500 cm³ fresh tap water at room temperature (25° C.). To the slurry is added 0.5 weight percent methylhydroxyethyl cellulose (HEMC), weight percents are based on the weight of the cement. The resultant slurry is kept agitated by occasional stirring. The amount of fluid loss is determined at 165° F. and 225° F. according to Recommended Practice for Testing Well Cements, API Recommended Practice 10B-2, 23^{rd} Edition (2002), incorporated herein by reference. Standard API viscosity reading readings are measured at 20° C. using a FANN 35 viscometer as described in ASTM D-2364. The results are tabulated in Table 2.

TABLE 2

| | Ex 1 | Com Ex A | Com Ex B | Com Ex C |
|---|---|---|---|---|
| Viscosity, cp | 175 | >800 | >800 | >800 |
| Fluid Loss@ 165° F., cm³/ | 25 | 45 | 33 | 80 |
| 30 min | | | | |
| Fluid Loss @ 225° F., cm³/ | 125 | >300 | >300 | >300 |
| 30 min | | | | |

The data clearly demonstrates cementing compositions of the present invention demonstrate improve fluid loss and thermal stability.

What is claimed is:

1. An aqueous cementing slurry composition for cementing a pipe or casing in a borehole of a well comprising:
(a) a hydraulic cement,
(b) a methylhydroxyethyl cellulose (HEMC) having an ethylene oxide molar substitution (EO MS) of from 0.16 to 0.22 and a methyl degree of substitution (M DS) of from 1.33 to 1.45,
(c) water,
and
(d) optionally one or more other additives conventionally added to aqueous cementing slurry compositions useful in cementing a pipe or casings in the borehole of wells.

2. The composition of claim 1 wherein the HEMC is present in an amount of from 0.1 to 0.5 weight percent based on the weight of the cement (bwoc).

3. The composition of claim 1 wherein the amount of fluid loss of the cementing composition is less than 30 cm³/30 minutes at 165° F. according to ISO 10B-2.

4. The composition of claim 1 wherein the HEMC comprise particle size fractions of:
(1) at least 95 percent less than 0.8 mm,
(2) at least 70 percent less than 0.63 mm,
and
(3) at least 30 percent less than 0.2 mm,
wherein particle size fractions are determined by laser diffraction.

5. The composition of claim 1 having a viscosity equal to or less than 300 cp measured at 20° C. using a FANN 35 viscometer as described in ASTM D-2364.

6. A method for cementing a pipe or casing in a borehole of a well comprising the use of an aqueous cementing slurry composition comprising the steps of:
i) introducing into the borehole the aqueous cementing slurry composition which comprises:
(a) a hydraulic cement,
(b) a methylhydroxyethyl cellulose (HEMC) having an ethylene oxide molar substitution (EO MS) of from 0.16 to 0.22 and a methyl degree of substitution (M DS) of from 1.33 to 1.45,
(c) water,
and
(d) optionally one or more other additives conventionally added to aqueous cementing slurry compositions useful in cementing a pipe or casings in the borehole of wells
and
ii) allowing the cementing composition to set.

7. The method of claim 6 wherein the HEMC is present in the cementing composition in an amount of from 0.1 to 0.5 weight percent based on the weight of the cement (bwoc).

8. The method of claim 6 wherein the amount of fluid loss of the cementing composition is less than 30 cm3/30 minutes at 165° F. according to ISO 10B-2.

9. The method of claim 2 wherein the HEMC comprise particle size fractions of:
(1) at least 95 percent less than 0.8 mm,
(2) at least 70 percent less than 0.63 mm,
and
(3) at least 30 percent less than 0.2 mm,
wherein particle size fractions are determined by laser diffraction.

10. The method of claim 6 wherein the aqueous cementing slurry composition has a viscosity equal to or less than 300 cp measured at 20° C. using a FANN 35 viscometer as described in ASTM D-2364.

11. The method of claim 1 wherein the well is an oil well.

12. The method of claim 1 wherein the well is an gas well.
